(19) United States
(12) Patent Application Publication
(10) Pub. No.: US 2025/0289959 A1
(43) Pub. Date: Sep. 18, 2025

(54) Carbon Blacks Based on Renewable Carbon Black Feedstocks

(71) Applicant: Orion Engineered Carbons IP GmbH & Co. KG, Monheim (DE)

(72) Inventors: Hauke Westenberg, Brühl (DE); Werner Niedermeier, Brühl (DE); Robert Meyer, Langenhagen (DE)

(21) Appl. No.: 18/861,044

(22) PCT Filed: Apr. 18, 2023
(86) PCT No.: PCT/EP2023/060008

§ 371 Date: Oct. 28, 2024

(30) Foreign Application Priority Data
Apr. 29, 2022 (EP) 22170979.3

(51) Int. Cl. C09C 1/48; B60C 1/00; C08K 3/04

(52) U.S. Cl. CPC C09C 1/482; C08K 3/04; B60C 1/00; C01P 2006/12; C01P 2006/19; C08K 2201/006

(57) ABSTRACT

The present invention relates to a process for producing carbon black and to carbon black obtained by such process as well as use of such carbon black. The present invention further relates to compositions comprising such carbon black and uses of such compositions.

### CROSS-REFERENCE TO RELATED APPLICATIONS

This application is the United States national phase of International Patent Application No. PCT/EP2023/060008 filed Apr. 18, 2023, and claims priority to European Patent Application No. 22170979.3 filed Apr. 29, 2022, the disclosures of which are hereby incorporated by reference in their entireties.

### BACKGROUND OF THE INVENTION

### Technical Field

The present invention relates to a process for producing carbon black and to carbon black obtained by such process as well as use of such carbon black. The present invention further relates to compositions comprising such carbon black and uses of such compositions.

### Technical Background

Carbon blacks are used in many applications, e.g., as fillers or pigments, because of their unique properties. However, carbon blacks are conventionally produced using fossil raw materials, such as coal and crude oil. Fossil raw materials are limited and they are depleting at a fast rate. Moreover, fossil raw materials mainly have a negative impact on the environment, as their extraction and transport can have a high environmental impact. For example, oil spills have occurred in the past leading to pollution of water bodies and death of aquatic animals including those living offshore. In addition, the combustion of fossil raw materials and thus production of carbon dioxide is known to be one of the primary factors responsible for global warming. Unstable prices and dependence on politically unstable regions for the transport of fossil raw materials are further reasons for the pursuit of alternatives to fossil raw materials.

It is desirable to avoid the disadvantages derived from the use of fossil raw materials. Renewable materials used as feedstock for the production of carbon blacks is more environmentally friendly. Renewable feedstock, such as plant-based renewable feedstock, are carbon dioxide neutral, since the combustion of plant-based feedstock only releases as much carbon dioxide into the atmosphere as was absorbed by the plants during their life cycle. The use of renewable feedstock contributes to the preservation of limited fossil resources and it creates opportunities for the realization of a circular economy.

Depending on the various applications, it is desirable that carbon black materials produced from renewable feedstocks exhibit certain properties comparable to known carbon blacks. This can however be challenging when renewable carbon black feedstocks are used.

### SUMMARY OF THE INVENTION

It is therefore an objective of the present invention to provide a process to produce carbon black which creates opportunities for the realization of a circular economy and provides for carbon blacks having comparable properties to known and established carbon blacks. It is further an objective to provide rubber compositions, which improve the CO₂ balance and still provide comparable mechanical properties, suitable e.g. for the production of tires and mechanical rubber goods. The rubber compositions further should be well processable and efficiently achievable at low costs from readily available materials.

It has surprisingly been shown, that the objective can be solved by the process and the carbon black obtained by the process as disclosed in the independent claims. Specific or preferred variants of the present invention are set forth in the dependent claims.

The following clauses summarize some aspects of the present invention.

A first aspect of the present invention relates to a process for producing carbon black through thermal oxidative pyrolysis or thermal cleavage of a carbon black feedstock, wherein the carbon black feedstock comprises (a) renewable carbon black feedstock and (b) rubber-derived pyrolysis oil.

A second aspect of the present invention relates to the process according to the first aspect, wherein the rubber-derived pyrolysis oil (b) comprises tire-derived pyrolysis oil (TPO).

A third aspect of the present invention relates to the process according to the first aspect or second aspect, wherein the rubber-derived pyrolysis oil (b) consists of tire-derived pyrolysis oil (TPO).

A fourth aspect of the present invention relates to the process according to any one of the preceding aspects, wherein the rubber-derived pyrolysis oil (b) has:
a total carbon in a range of from 80.0 to 90.0 mass %;
a total hydrogen in a range of 8.0 to 15.0 mass %; and
a C/H atomic ratio in a range of from 0.60 to 1.0;
wherein the mass % is based on the total mass of the rubber-derived pyrolysis oil excluding water and ash content and wherein the total carbon and the total hydrogen are determined according to ASTM D5291C-21.

A fifth aspect of the present invention relates to the process according to any one of the preceding aspects, wherein the rubber-derived pyrolysis oil (b) has:
a total carbon in a range of from 85.0 to 90.0 mass %;
a total hydrogen in a range of 8.0 to 11.0 mass %; and
a C/H atomic ratio in a range of from 0.65 to 1.0;
wherein the mass % is based on the total mass of the rubber-derived pyrolysis oil excluding water and ash content and wherein the total carbon and the total hydrogen are determined according to ASTM D5291C-21.

A sixth aspect of the present invention relates to the process according to any one of the preceding aspects, wherein the rubber-derived pyrolysis oil (b) has:
a total carbon in a range of from 86.0 to 90.0 mass %;
a total hydrogen in a range of 8.5 to 10.5 mass %; and
a C/H atomic ratio in a range of from 0.70 to 0.90;

wherein the mass % is based on the total mass of the rubber-derived pyrolysis oil excluding water and ash content and wherein the total carbon and the total hydrogen are determined according to ASTM D5291C-21.

A seventh aspect of the present invention relates to the process according to any one of the preceding aspects, wherein the rubber-derived pyrolysis oil (b) has:
a total carbon in a range of from 87.0 to 90.0 mass %;
a total hydrogen in a range of 9.0 to 10.0 mass %; and
a C/H atomic ratio in a range of from 0.70 to 0.85;
wherein the mass % is based on the total mass of the rubber-derived pyrolysis oil excluding water and ash content and wherein the total carbon and the total hydrogen are determined according to ASTM D5291C-21.

An eighth aspect of the present invention relates to the process according to any one of the preceding aspects, wherein the rubber-derived pyrolysis oil (b) has:
a total nitrogen of up to 1.00 mass %; and/or
a total sulfur of up to 1.35 mass %;
wherein the mass % is based on the total mass of the rubber-derived pyrolysis oil excluding water and ash content and wherein the total nitrogen and the total sulfur are determined according to ASTM D5291C-21.

A ninth aspect of the present invention relates to the process according to any one of the preceding aspects, wherein the rubber-derived pyrolysis oil (b) has:
a total nitrogen of up to 0.80 mass %; and/or
a total sulfur of up to 1.25 mass %;
wherein the mass % is based on the total mass of the rubber-derived pyrolysis oil excluding water and ash content and wherein the total nitrogen and the total sulfur are determined according to ASTM D5291C-21.

A tenth aspect of the present invention relates to the process according to any one of the preceding aspects, wherein the rubber-derived pyrolysis oil (b) has:
a total nitrogen of up to 0.65 mass %; and/or
a total sulfur of up to 1.20 mass %;
wherein the mass % is based on the total mass of the rubber-derived pyrolysis oil excluding water and ash content and wherein the total nitrogen and the total sulfur are determined according to ASTM D5291C-21.

An eleventh aspect of the present invention relates to the process according to any one of the preceding aspects, wherein the rubber-derived pyrolysis oil (b) has:
an ash content of less than 0.04 mass %, wherein the mass % is based on the total mass of the rubber-derived pyrolysis oil and wherein the ash content is determined according to ASTM D2415-20.

A twelfth aspect of the present invention relates to the process according to any one of the preceding aspects, wherein the rubber-derived pyrolysis oil (b) has:
an ash content of less than 0.03 mass %, wherein the mass % is based on the total mass of the rubber-derived pyrolysis oil and wherein the ash content is determined according to ASTM D2415-20.

A thirteenth aspect of the present invention relates to the process according to any one of the preceding aspects, wherein the rubber-derived pyrolysis oil (b) has:
a sieve residue of up to 250 mg/kg, based on the total weight of the rubber-derived pyrolysis oil and determined according to ASTM D4870-18 (25 μm mesh size).

A fourteenth aspect of the present invention relates to the process according to any one of the preceding aspects, wherein the rubber-derived pyrolysis oil (b) has:
a sieve residue of up to 230 mg/kg, based on the total weight of the rubber-derived pyrolysis oil and determined according to ASTM D4870-18 (25 μm mesh size).

A fifteenth aspect of the present invention relates to the process according to any one the second to fourteenth aspects, wherein the tire-derived pyrolysis oil (TPO) has:
a total carbon in a range of from 85.0 to 90.0 mass %;
a total hydrogen in a range of 8.0 to 11.0 mass %; and
a C/H atomic ratio in a range of from 0.65 to 1.0;
wherein the mass % is based on the total mass of the TPO excluding water and ash content and wherein the total carbon and the total hydrogen are determined according to ASTM D5291C-21.

A sixteenth aspect of the present invention relates to the process according to any one of the second to fifteenth aspects, wherein the TPO has:
a total carbon in a range of from 86.0 to 90.0 mass %;
a total hydrogen in a range of 8.5 to 10.5 mass %; and
a C/H atomic ratio in a range of from 0.70 to 0.90;
wherein the mass % is based on the total mass of the TPO excluding water and ash content and wherein the total carbon and the total hydrogen are determined according to ASTM D5291C-21.

A seventeenth aspect of the present invention relates to the process according to any one of the second to sixteenth aspects, wherein the TPO has:
a total carbon in a range of from 87.0 to 90.0 mass %;
a total hydrogen in a range of 9.0 to 10.0 mass %; and
a C/H atomic ratio in a range of from 0.70 to 0.85;
wherein the mass % is based on the total mass of the TPO excluding water and ash content and wherein the total carbon and the total hydrogen are determined according to ASTM D5291C-21.

An eighteenth aspect of the present invention relates to the process according to any one of the second to seventeenth aspects, wherein the TPO has:
a total nitrogen of from 0.40 to 0.65 mass %; and/or
a total sulfur of up to 1.35 mass %;
wherein the mass % is based on the total mass of the TPO excluding water and ash content and wherein the total nitrogen and the total sulfur are determined according to ASTM D5291C-21.

A nineteenth aspect of the present invention relates to the process according to any one of the second to seventeenth aspects, wherein the TPO has:
a total nitrogen of from 0.45 to 0.65 mass %; and/or
a total sulfur of up to 1.25 mass %;
wherein the mass % is based on the total mass of the TPO excluding water and ash content and wherein the total nitrogen and the total sulfur are determined according to ASTM D5291C-21.

A twentieth aspect of the present invention relates to the process according to any one of the second to nineteenth aspects, wherein the TPO has:
a total nitrogen of from 0.45 to 0.60 mass %; and/or
a total sulfur of up to 1.20 mass %;
wherein the mass % is based on the total mass of the TPO excluding water and ash content and wherein the total nitrogen and the total sulfur are determined according to ASTM D5291C-21.

A twenty-first aspect of the present invention relates to the process according to one of the second to twentieth aspects, wherein the TPO has:
an ash content of less than 0.04 mass %, wherein the mass % is based on the total mass of the TPO and wherein the ash content is determined according to ASTM D2415-20.

A twenty-second aspect of the present invention relates to the process according to one of the second to twenty-first aspects, wherein the TPO has:
an ash content of less than 0.03 mass %, wherein the mass % is based on the total mass of the TPO and wherein the ash content is determined according to ASTM D2415-20.

A twenty-third aspect of the present invention relates to the process according to any one of the second to twenty-second aspects, wherein the TPO has:
a sieve residue of up to 250 mg/kg, based on the total weight of the TPO and determined according to ASTM D4870-18 (25 μm mesh size).

A twenty-fourth aspect of the present invention relates to the process according to any one of the second to twenty-third aspects, wherein the TPO has:
a sieve residue of up to 230 mg/kg, based on the total weight of the TPO and determined according to ASTM D4870-18 (25 μm mesh size).

A twenty-fifth aspect of the present invention relates to the process according to any one of the preceding aspects, wherein the renewable carbon feedstock (a) comprises a plant-based feedstock.

A twenty-sixth aspect of the present invention relates to the process according to any one of the preceding aspects, wherein the renewable carbon black feedstock (a) comprises woods, grass, cellulose, hemicellulose, lignin, black liquor, tall oil, rubber seed oil, tobacco seed oil, castor oil, pongamia oil, crambe oil, neem oil, apricot kernel oil, rice bran oil, cashew nut shell oil, Cyperus esculentus oil, rice bran oil, rapeseed oil, linseed oil, palm oil, coconut oil, canola oil, soybean oil, sunflower oil, cotton seed oil, pine seed oil, olive oil, corn oil, grape seed oil, safflower oil, acai palm oil, jambú oil, sesame oil, chia seed oil, hemp oil, perilla oil, peanut oil, stillingia oil, cashew nut oil, brazil nut oil, macadamia nut oil, walnut oil, almond oil, hazel nut oil, beechnut oil, candlenut oil, chestnut oil or a mixture or combination of any of the foregoing.

A twenty-seventh aspect of the present invention relates to the process according to any one of the preceding aspects, wherein the renewable carbon black feedstock (a) comprises soybean oil, rapeseed oil or a mixture or combination of any of the foregoing.

A twenty-eighth aspect of the present invention relates to the process according to any one of the preceding aspects, wherein the renewable carbon black feedstock (a) comprises rapeseed oil.

A twenty-ninth aspect of the present invention relates to the process according to any one of the preceding aspects, wherein the rubber-derived pyrolysis oil comprises at least 10 wt.-%, preferably at least 30 wt.-%, more preferably at least 50 wt.-%, even more preferably at least 70 wt.-%, most preferably at least 90 wt.-% of the tire-derived pyrolysis oil (TPO), based on the total weight of the rubber-derived pyrolysis oil.

A thirtieth aspect of the present invention relates to the process according to any one of the preceding aspects, wherein the carbon black feedstock has a ratio of the renewable carbon black feedstock (a) to the rubber-derived pyrolysis oil of from 0.1:1 to 1:0.1, preferably 0.3:1 to 1:0.3.

A thirty-first aspect of the present invention relates to the process according to any one of the preceding aspects, wherein the carbon black feedstock has a ratio of the renewable carbon black feedstock (a) to the rubber-derived pyrolysis oil of from 0.5:1 to 1:0.5.

A thirty-second aspect of the present invention relates to the process according to any one of the preceding aspects, wherein the carbon black feedstock comprises:
(a) 10 to 90 wt.-%, preferably 20 to 80 wt.-%, more preferably 40 to 60 wt.-%, most preferably 45 to 55 wt.-% of the renewable carbon black feedstock, based on the total weight of the carbon black feedstock.

A thirty-third aspect of the present invention relates to the process according to any one of the preceding aspects, wherein the carbon black feedstock comprises:
(b) 10 to 90 wt.-% preferably 20 to 80 wt.-%, more preferably 40 to 60 wt.-%, most preferably 45 to 55 wt.-% of the rubber-derived pyrolysis oil, based on the total weight of the carbon black feedstock.

A thirty-forth aspect of the present invention relates to the process according to any one of the preceding aspects comprising feeding an O₂-containing gas stream and a fuel stream comprising combustible material to the reactor; subjecting the combustible material to combustion in a combustion step to provide a combustion gas stream, wherein the O₂-containing gas stream and the fuel stream comprising combustible material are provided for the combustion step in amounts corresponding to a k factor in the range of from 0.5 to 1.0, wherein the k factor is the ratio of O₂ theoretically necessary for stoichiometric combustion of all combustible material in the combustion step to the total O₂ provided for the combustion step; contacting the carbon black feedstock with the combustion gas stream in a reaction step to form carbon black; and terminating the carbon black formation reaction in a terminating step.

A thirty-fifth aspect of the present invention relates to the process according to the thirty-fourth aspect, wherein the k factor is in the range of from 0.6 to 1.0, preferably from 0.7 to 1.0, more preferably from 0.75 to 1.0, even more preferably from 0.8 to 1.0.

A thirty-sixth aspect of the present invention relates to the process according to any one of the preceding aspects, wherein the reaction is carried out in a furnace-black reactor.

A thirty-seventh aspect of the present invention relates to a carbon black obtained by the process according to any of the preceding aspects.

A thirty-eighth aspect of the present invention relates to the carbon black according to the thirty-seventh aspect, wherein the carbon black has:
an oil absorption number (OAN) of equal to or more than 70 mL/100 g;
wherein the OAN is determined according to ASTM D2414-21.

A thirty-ninth aspect of the present invention relates to the carbon black according to the thirty-seventh or the thirty-eighth aspect, wherein the carbon black has:
a difference (gap) between the OAN and COAN in a range of from 10 to 45 mL/100 g;
wherein the OAN is determined according to ASTM D2414-21, the COAN is determined according to ASTM D3493-21.

A fortieth aspect of the present invention relates to the carbon black according to any one of the thirty-seventh to thirty-ninth aspects, wherein the carbon black has
a statistical thickness surface area (STSA) of no more than or equal to 90 m²/g;
wherein the STSA is determined according to ASTM D6556-19a.

A forty-first aspect of the present invention relates to the carbon black according to any one of the thirty-seventh to fortieth aspects, wherein the carbon black has an OAN in a range of from 70 to 145 mL/100 g; wherein the OAN is determined according to ASTM D2414-21.

A forty-second aspect of the present invention relates to the carbon black according to any one of the thirty-seventh to forty-first aspects, wherein the carbon black has a difference (gap) between the OAN and COAN in a range of from 10 to 40 mL/100 g, preferably from 12 to 35 mL/100 g, more preferably from 12 to 30 mL/100 g; wherein the OAN is determined according to ASTM D2414-21 and the COAN is determined according to ASTM D3493-21.

A forty-third aspect of the present invention relates to the carbon black according to any one of the thirty-seventh to forty-second aspects, wherein the carbon black has a STSA in a range of from 20 to 90 m²/g, preferably from 23 to 90 m²/g, more preferably 25 to 85 m²/g; wherein the STSA is determined according to ASTM D6556-19a.

A forty-fourth aspect of the present invention relates to the carbon black according to any one of the thirty-seventh to forty-third aspects, wherein the carbon black has a BET surface area in a range of from 20 to 120 m²/g, preferably from 23 to 110 m²/g, further preferably from 25 to 100 m²/g; wherein the BET surface area is determined according to ASTM D6556-19a.

A forty-fifth aspect of the present invention relates to the carbon black according to any one of the thirty-seventh to forty-fourth aspects, wherein the carbon black has a sulfur content of no more than 2.5%, preferably no more than 2.0%, more preferably no more than 1.5%; wherein the sulfur content is determined according to ASTM D1619-20.

A forty-sixth aspect of the present invention relates to the carbon black according to any one of the thirty-seventh to forty-fifth aspects, wherein the carbon black has a pMC (percent of modern carbon) of 30% or more, preferably of 40% or more, more preferably of 50% or more, even more preferably of 75% or more, most more preferably of 90% or more, wherein the pMC is determined according to ASTM D6866-20 Methode B (AMS).

A forty-seventh aspect of the present invention relates to the carbon black according to any one of the thirty-seventh to forty-sixth aspects, wherein the carbon black is a furnace black.

A forty-eighth aspect of the present invention relates to the carbon black according to any one of the thirty-seventh to forty-seventh aspects, wherein the carbon black is oxidized and/or functionalized.

A forty-ninth aspect of the present invention relates to use of the carbon black according to any one of the thirty-seventh to forty-eighth aspects as reinforcing filler or additives, UV stabilizer, conductive carbon black or pigment, preferably reinforcing filler or additives.

A fiftieth aspect of the present invention relates to use of the carbon black according to any one of the thirty-seventh to forty-eighth aspects in rubber and rubber mixtures, plastics, inks such as printing inks, inkjet inks or other inks, toners, lacquers, coatings, papers, adhesives, in batteries or black matrix applications, preferably in rubber and rubber mixtures or plastics.

A fifty-first aspect of the present invention relates to a rubber composition, comprising at least one rubber material and at least one carbon black according to any one of the thirty-seventh to forty-eighth aspects.

A fifty-second aspect of the present invention relates to the rubber composition according to the fifty-first aspect, wherein the at least one rubber material comprises natural rubber, styrene-butadiene rubber such as emulsion-styrene-butadiene rubber and solution-styrene-butadiene rubber, polybutadiene, polyisoprene, ethylene-propylene-diene rubber, ethylene-propylene rubber, butyl rubber, halogenated butyl rubber, chlorinated polyethylene, chlorosulfonated polyethylene, acrylonitrile-butadiene rubber, hydrogenated acrylonitrile-butadiene rubber, polychloroprene, acrylate rubber, ethylene-vinylacetate rubber, ethylene-acrylic rubber, epichlorohydrin rubber, silicone rubber, fluorosilicone rubber, fluorocarbon rubber or a mixture or combination of any of the foregoing.

A fifty-third aspect of the present invention relates to use of the rubber composition according to the fifty-first or the fifty-second aspect, for producing a tire, preferably a pneumatic tire, a tire tread, a belt, a belt reinforcement, a carcass, a carcass reinforcement, a sidewall, inner liner, apex, shoulder, hump strip, chafer, a bead filler, a cable sheath, a tube, a drive belt, a conveyor belt, a roll covering, a shoe sole, a hose, a sealing member, a profile, a damping element, a coating or a colored or printed article.

A fifty-fourth aspect of the present invention relates to a tire made of the rubber composition according to the fifty-first or the fifty-second aspect.

A fifty-fifth aspect of the present invention relates to the tire according to the fifty-fourth aspect, wherein the tire comprises a tire tread, a belt, a belt reinforcement, a carcass, a carcass reinforcement, a sidewall, inner liner, apex, shoulder, hump strip, chafer and a bead filler, wherein at least one of the foregoing is made of the rubber composition according to the fifty-first or the fifty-second aspect.

A fifty-sixth aspect of the present invention relates to the tire according to the fifty-fourth or fifty-fifth aspect, wherein the tire has a circumferential tread of a cap/base configuration comprising a circumferential outer tread cap rubber layer which contains a running surface for the tire and a tread base rubber layer at least partially underlaying said tread cap rubber layer, wherein at least one of said tread cap rubber layer and said tread base rubber layer is made of the rubber composition according to the fifty-first or the fifty-second aspect.

A fifty-seventh aspect of the present invention relates to an article made of the rubber composition according to the fifty-first or the fifty-second aspect being a cable sheath, a tube, a drive belt, a conveyor belt, a roll covering, a shoe sole, a hose, a sealing member, a profile, a damping element, a coating or a colored or printed article.

A fifty-eighth aspect of the present invention relates to a plastic composition comprising at least one plastic material and at least one carbon black according to any one the thirty-seventh to forty-eighth aspects.

A fifty-ninth aspect of the present invention relates to the plastic composition according to the fifty-eighth aspect, wherein the at least one plastic material comprises a thermoplastic polymer, a thermosetting polymer, a thermoplastic elastomer, preferably low and high density polyethylene and polypropylene, polyvinyl chloride, melamine-formaldehyde resin, phenolic resin, epoxy resin, polyamide, polyester, polyoxymethylene, polymethyl methacrylate, polycarbonate, polystyrene, polyurethane, polyphenylene oxide, polysiloxane, polyacryloamide, polyaryletherketone, polysulfone, polyetherimide, acrylonitrile styrene acrylate or acrylonitrile butadiene styrene polymer and mixtures or co-polymers of any of the foregoing.

### BRIEF DESCRIPTION OF THE DRAWING

FIG. 1 (not to scale) shows a schematic cross-section of a furnace carbon black reactor.

### DESCRIPTION OF THE INVENTION

The present invention relates to a process for producing carbon black through thermal oxidative pyrolysis or thermal cleavage of a carbon black feedstock. The carbon black feedstock of the present invention comprises (a) renewable carbon black feedstock and (b) rubber-derived pyrolysis oil.

As used herein, the term “carbon black” relates to a material composed substantially, e.g., to more than 80 wt. %, or more than 90 wt. % or more than 95 wt. %, based on its total weight of carbon. The production of carbon blacks is per se well known in the art and for example outlined in J.-B. Donnet et al., “Carbon Black: Science and Technology”, 2nd edition as well as in H. Ferch “Pigmentruße”, 1st edition, Curt R. Vincentz Verlag, Hannover (1995) and will be further described below.

As used herein, the term “rubber-derived pyrolysis oil” relates to the liquid fraction obtained in the pyrolysis of rubber articles. The rubber-derived pyrolysis oil typically contains a mixture of saturated and unsaturated hydrocarbons and may contain polar compounds including sulfur, nitrogen and oxygen.

The pyrolysis of rubber articles generally involves heating the rubber articles to temperatures, e.g., of at least 300° C. in the absence of oxygen in order to volatilize and decompose the rubber articles, producing oil, gas, and char. As used herein, the term “rubber articles” refers to articles composed of rubber, e.g., composed of at least 50 wt.-% of rubber, based on the total weight of the rubber article. Examples of rubber articles include, but are not limited to, tires, conveyer belts, gaskets, such as door gaskets, drive belts, floor mats, shoe soles, belts, cable sheaths, hoses, and the like. Preferred rubber articles include tires. The term “rubber” includes both natural and synthetic rubbers or mixtures thereof. Natural rubber may be obtained from rubber trees (Helvea brasiliensis), guayule, and dandelion. Synthetic rubber may comprise styrene-butadiene rubber such as emulsion-styrene-butadiene rubber and solution-styrene-butadiene rubber, polybutadiene, polyisoprene, ethylene-propylene-diene rubber, ethylene-propylene rubber, butyl rubber, halogenated butyl rubber, chlorinated polyethylene, chlorosulfonated polyethylene, acrylonitrile-butadiene rubber, hydrogenated acrylonitrile-butadiene rubber, polychloroprene, acrylate rubber, ethylene-vinylacetate rubber, ethylene-acrylic rubber, epichlorohydrin rubber, silicone rubber, fluorosilicone rubber, fluorocarbon rubber or mixture of combinations of any of the foregoing.

According to the present invention, the rubber-derived pyrolysis oil may comprise tire-derived pyrolysis oil (TPO). As used herein, the term “tire-derived pyrolysis oil” (“TPO”) relates to the liquid fraction obtained in the pyrolysis of tires in the absence of oxygen. The TPO generally contains a mixture of saturated and unsaturated hydrocarbons and may contain polar compounds including sulfur, nitrogen and oxygen. Typically, waste tires, which are also known as “end-of-life” tires (ELT) are used in the pyrolysis to obtain TPO. As used herein, “waste tires” or “end-of-life tires” refer to tires, such as truck tires, passenger tires, off-road tires, aircraft tires, agricultural tires, and earth-mover tires, which are not suitable for use on vehicles due to, e.g., wear or irreparable damage such as punctures.

The process of pyrolysis of rubber articles, such as tires is well known in the art and involves heating the tires in the absence of oxygen. Suitable processes for obtaining rubber-derived pyrolysis oil, and in particular TPO, include, but are not limited to those which are described in US 2002/0072641 A1, US 2002/0072640 A1, US2005/0101812 A1 and EP 2 427 533 A1.

The rubber-derived pyrolysis oil may comprise at least 5 wt.-%, such as at least 10 wt.-%, or at least wt.-%, or at least 15 wt.-%, or at least 20 wt.-%, or at least 25 wt.-%, or at least 30 wt.-%, or at least 35 wt.-%, or at least 40 wt.-%, or at least 45 wt.-%, or at least 50 wt.-%, or at least 55 wt.-%, or at least 60 wt.-%, or at least 65 wt.-%, or at least 70 wt.-%, or at least 75 wt.-%, or at least 80 wt.-%, or at least 85 wt.-%, or at least 90 wt.-%, or at least 95 wt.-%, or at least 99 wt.-% of tire-derived pyrolysis oil (TPO), based on the total weight of the rubber-derived pyrolysis oil. According to the present invention, the rubber-derived pyrolysis oil may comprise at least 10 wt.-%, preferably at least 30 wt.-%, more preferably at least 50 wt.-%, even more preferably at least 70 wt.-%, most preferably at least 90 wt.-% of TPO, based on the total weight of the rubber-derived pyrolysis oil. The rubber-derived pyrolysis oil of the present invention may consist of TPO.

Suitable examples of rubber-derived pyrolysis oil, and in particular TPO, include, but are not limited to, ThermoTireOil RR, commercially available from Pyrum Innovations AG (Germany).

According to the invention, the rubber-derived pyrolysis oil may have a flash point of at least 3° C., preferably at least 5° C., more preferably 50° C., most preferably at least 65° C. As used herein, the term “flash point” relates to the lowest temperature at which a volatile material vaporizes to form an ignitable mixture in air. The flash point may be determined according to ASTM D93 D. The rubber-derived pyrolysis oil may be treated by distillation, such as fractional distillation at atmospheric pressure, thin film distillation, or the like, to obtain fractions having a higher flash point of, e.g., of at least 65° C.

According to the present invention, the rubber-derived pyrolysis oil (b) may have a total carbon of at least 80.0 mass %, such as at least 81.0 mass %, or at least 82.0 mass %, or at least 83.0 mass %, or at least 84.0 mass %, or at least 85.0 mass %, or at least 85.5 mass %, or at least 86.0 mass %, or at least 86.5 mass %, or at least 87.0 mass %, or at least 87.5 mass %, wherein the mass % is based on the total mass of the rubber-derived pyrolysis oil excluding water and ash content. The rubber-derived pyrolysis oil (b) may have a total carbon of 90.0 mass % or less, such as 89.5 mass % or less, or 89.0 mass % or less, wherein the mass % is based on the total mass of the rubber-derived pyrolysis oil excluding water and ash content. The water content may be determined according to ASTM D4928-12R18 and the ash content may be determined according to ASTM D2415-20 (at 550° C.). A person skilled in the art will appreciate that any range between any of the explicitly disclosed lower and upper limit is herein disclosed. Accordingly, the rubber-derived pyrolysis oil (b) may have a total carbon in a range of from 80.0 to 90.0 mass %, preferably from 85.0 to 90.0 mass %, more preferably from 86.0 to 90.0 mass %, most preferably from 87.0 to 90.0 mass %, wherein the mass % is based on the total mass of the rubber-derived pyrolysis oil excluding water and ash content. The total carbon is determined according to ASTM D5291C-21.

According to the present invention, the rubber-derived pyrolysis oil (b) may have a total hydrogen of at least 8.0 mass %, such as at least 8.5 mass %, or at least 9.0 mass %, or at least 9.5 mass %, wherein the mass % is based on the total mass of the rubber-derived pyrolysis oil excluding water and ash content. The water content may be determined according to ASTM D4928-12R18 and the ash content may be determined according to ASTM D2415-20 (at 550° C.). The rubber-derived pyrolysis oil (b) may have a total hydrogen of 15.0 mass % or less, such as 14.0 mass % or less, or 13.0 mass % or less, or 12.0 mass % or less, or 11.0 mass % or less, or 10.5 mass % or less, or 10.0 mass % or less, wherein the mass % is based on the total mass of the rubber-derived pyrolysis oil excluding water and ash content. A person skilled in the art will appreciate that any range between any of the explicitly disclosed lower and upper limit is herein disclosed. Accordingly, the rubber-derived pyrolysis oil (b) may have a total hydrogen in a range of from 8.0 to 15.0 mass %, preferably from 8.0 to 11.0 mass %, more preferably from 8.5 to 10.5 mass %, most preferably from 9.0 to 10.0 mass %, wherein the mass % is based on the total mass of the rubber-derived pyrolysis oil excluding water and ash content. The total hydrogen is determined according to ASTM D5291C-21.

According to the present invention, the rubber-derived pyrolysis oil (b) may have a C/H atomic ratio of at least 0.60, such as at least 0.65, or at least 0.70, or at least 0.75. The rubber-derived pyrolysis oil may (b) have a C/H atomic ratio of 1.0 or less, such as 0.95 or less, or 0.90 or less, or 0.85 or less, or 0.80 or less. A person skilled in the art will appreciate that any range between any of the explicitly disclosed lower and upper limit is herein disclosed. Accordingly, the rubber-derived pyrolysis oil (b) may have a C/H atomic ratio in a range of from 0.60 to 1.0, preferably from 0.65 to 1.0, preferably from 0.70 to 0.90, more preferably from 0.70 to 0.85. The C/H atomic ratio is calculated from the total carbon and the total hydrogen, which are determined as described above according to ASTM D5291C-21.

The rubber-derived pyrolysis oil (b) may have:
a total carbon in a range of from 80.0 to 90.0 mass %, preferably from 85.0 to 90.0 mass %, more preferably from 86.0 to 90.0 mass %, most preferably from 87.0 to 90.0 mass %;
a total hydrogen in a range of 8.0 to 15.0 mass %, preferably from 8.0 to 11.0 mass %, more preferably from 8.5 to 10.5 mass %, most preferably from 9.0 to 10.0 mass %; and
a C/H atomic ratio in a range of from 0.60 to 1., preferably from 0.65 to 1.0, more preferably from 0.70 to 0.90, most preferably from 0.70 to 0.85;
wherein the mass % is based on the total mass of the rubber-derived pyrolysis oil excluding water and ash content. The total carbon and the total hydrogen are determined according to ASTM D5291C-21. The C/H atomic ratio is calculated from the total carbon and the total hydrogen. The water content may be determined according to ASTM D4928-12R18 and the ash content may be determined according to ASTM D2415-20 (at 550° C.).

According to the present invention, the rubber-derived pyrolysis oil (b) may have a total nitrogen of at least 0.01 mass %, such as at least 0.02 mass, wherein the mass % is based on the total mass of the rubber-derived pyrolysis oil excluding water and ash content. The water content may be determined according to ASTM D4928-12R18 and the ash content may be determined according to ASTM D2415-20 (at 550° C.). The rubber-derived pyrolysis oil (b) may have a total nitrogen of up to 1.00 mass %, such as up to 0.90 mass %, or up to 0.80 mass %, or up to 0.70 mass %, or up to 0.65 mass %, wherein the mass % is based on the total mass of the rubber-derived pyrolysis oil excluding water and ash content. A person skilled in the art will appreciate that any range between any of the explicitly disclosed lower and upper limit is herein disclosed. Accordingly, the rubber-derived pyrolysis oil (b) may have a total nitrogen in a range of from 0.01 to 1.00 mass %, such as from 0.01 to 0.80 mass %, or from 0.01 to 0.65 mass %, wherein the mass % is based on the total mass of the rubber-derived pyrolysis oil excluding water and ash content. The total nitrogen is determined according to ASTM D5291C-21.

According to the present invention, the rubber-derived pyrolysis oil (b) may have a total sulfur of up to 1.35 mass %, such as up to 1.30 mass %, or up to 1.25 mass %, or up to 1.20 mass %, or up to 1.15 mass %, or up to 1.10 mass %, wherein the mass % is based on the total mass of the rubber-derived pyrolysis oil excluding water and ash content. The water content may be determined according to ASTM D4928-12R18 and the ash content may be determined according to ASTM D2415-20 (at 550° C.). The total sulfur is determined according to ASTM D5291C-21.

The rubber-derived pyrolysis oil (b) may have:
a total nitrogen of up to 1.00 mass %, preferably up to 0.80 mass %, more preferably up to 0.65 mass %; and
a total sulfur of up to 1.35 mass %, preferably up to 1.25 mass %, more preferably up to 1.20 mass %;
wherein the mass % is based on the total mass of the rubber-derived pyrolysis oil excluding water and ash content. The total nitrogen and the total sulfur are determined according to ASTM D5291C-21. The water content may be determined according to ASTM D4928-12R18 and the ash content may be determined according to ASTM D2415-20 (at 550° C.).

According to the present invention, the rubber-derived pyrolysis oil (b) may have:
a total carbon in a range of from 80.0 to 90.0 mass %, preferably from 85.0 to 90.0 mass %, more preferably from 86.0 to 90.0 mass %, most preferably from 87.0 to 90.0 mass %;
a total hydrogen in a range of from 8.0 to 15.0, preferably from 8.0 to 11.0 mass %, more preferably from 8.5 to 10.5 mass %, most preferably from 9.0 to 10.0 mass %;
a C/H atomic ratio in a range of from 0.60 to 1.0, preferably from 0.65 to 1.0, more preferably from 0.70 to 0.90, most preferably from 0.70 to 0.85;
a total nitrogen of up to 1.00 mass %, preferably up to 0.80 mass %, more preferably up to 0.65 mass %; and
a total sulfur of up to 1.35 mass %, preferably up to 1.25 mass %, more preferably up to 1.20 mass %;
wherein the mass % is based on the total mass of the rubber-derived pyrolysis oil excluding water and ash content. The total carbon, total hydrogen, total nitrogen and total sulfur are determined according to ASTM D5291C-21. The C/H atomic ratio is calculated from the total carbon and the total hydrogen. The water content may be determined according to ASTM D4928-12R18 and the ash content may be determined according to ASTM D2415-20 (at 550° C.).

According to the present invention, the rubber-derived pyrolysis oil (b) may have an ash content of less than 0.04 mass %, such as less than 0.03 mass %, or less than 0.02 mass %, or less than 0.01 mass %, wherein the mass % is based on the total mass of the rubber-derived pyrolysis oil. The ash content is determined according to ASTM D2415-20 (at 550° C.).

The rubber-derived pyrolysis oil (b) may have a sieve residue of 250 mg/kg or less, such as 230 mg/kg or less, based on the total weight of the rubber-derived pyrolysis oil. The sieve residue is determined according to ASTM D4870-18 (25 μm mesh size).

According to the present invention, the TPO may have a total carbon of at least 85.0 mass %, such as at least 85.5 mass %, or at least 86.0 mass %, or at least 86.5 mass %, or at least 87.0 mass %, or at least 87.5 mass %, wherein the mass % is based on the total mass of the TPO excluding water and ash content. The water content may be determined according to ASTM D4928-12R18 and the ash content may be determined according to ASTM D2415-20 (at 550° C.). The TPO may have a total carbon of 90.0 mass % or less, such as 89.5 mass % or less, or 89.0 mass % or less, wherein the mass % is based on the total mass of the TPO excluding water and ash content. A person skilled in the art will appreciate that any range between any of the explicitly disclosed lower and upper limit is herein disclosed. Accordingly, the TPO may have a total carbon in a range of from 85.0 to 90.0 mass %, preferably from 86.0 to 90.0 mass %, more preferably from 87.0 to 90.0 mass %, wherein the mass % is based on the total mass of the TPO excluding water and ash content. The total carbon is determined according to ASTM D5291C-21.

According to the present invention, the TPO may have a total hydrogen of at least 8.0 mass %, such as at least 8.5 mass %, or at least 9.0 mass %, or at least 9.5 mass %, wherein the mass % is based on the total mass of the TPO excluding water and ash content. The water content may be determined according to ASTM D4928-12R18 and the ash content may be determined according to ASTM D2415-20 (at 550° C.). The TPO may have a total hydrogen of 11.0 mass % or less, such as 10.5 mass % or less, or 10.0 mass % or less, wherein the mass % is based on the total mass of the TPO excluding water and ash content. A person skilled in the art will appreciate that any range between any of the explicitly disclosed lower and upper limit is herein disclosed. Accordingly, the TPO may have a total hydrogen in a range of from 8.0 to 11.0 mass %, preferably from 8.5 to 10.5 mass %, more preferably from 9.0 to 10.0 mass %, wherein the mass % is based on the total mass of the TPO excluding water and ash content. The total hydrogen is determined according to ASTM D5291C-21.

According to the present invention, the TPO may have a C/H atomic ratio of at least 0.65, such as at least 0.70, or at least 0.75. The TPO may have a C/H atomic ratio of 1.0 or less, such as 0.95 or less, or 0.90 or less, or 0.85 or less, or 0.80 or less. A person skilled in the art will appreciate that any range between any of the explicitly disclosed lower and upper limit is herein disclosed. Accordingly, the TPO may have a C/H atomic ratio in a range of from 0.65 to 1.0, preferably from 0.70 to 0.90, more preferably from 0.70 to 0.85. The C/H atomic ratio is calculated from the total carbon and the total hydrogen, which are determined as described above according to ASTM D5291C-21.

The TPO may have:
a total carbon in a range of from 85.0 to 90.0 mass %, preferably from 86.0 to 90.0 mass %, more preferably from 87.0 to 90.0 mass %;
a total hydrogen in a range of 8.0 to 11.0 mass %, preferably from 8.5 to 10.5 mass %, more preferably from 9.0 to 10.0 mass %; and
a C/H atomic ratio in a range of from 0.65 to 1.0, preferably from 0.70 to 0.90, more preferably from 0.70 to 0.85;
wherein the mass % is based on the total mass of the TPO excluding water and ash content. The water content may be determined according to ASTM D4928-12R18 and the ash content may be determined according to ASTM D2415-20 (at 550° C.). The total carbon and the total hydrogen are determined according to ASTM D5291C-21. The C/H atomic ratio is calculated from the total carbon and the total hydrogen.

According to the present invention, the TPO may have a total nitrogen of at least 0.40 mass %, such as at least 0.45 mass %, or at least 0.50 mass %, wherein the mass % is based on the total mass of the TPO excluding water and ash content. The water content may be determined according to ASTM D4928-12R18 and the ash content may be determined according to ASTM D2415-20 (at 550° C.). The TPO may have a total nitrogen of 0.65 mass % or less, such as 0.60 mass % or less, or 0.55 mass % or less, wherein the mass % is based on the total mass of the TPO excluding water and ash content. A person skilled in the art will appreciate that any range between any of the explicitly disclosed lower and upper limit is herein disclosed. Accordingly, the TPO may have a total nitrogen in a range of from 0.40 to 0.65 mass %, preferably from 0.45 to 0.65 mass %, more preferably from 0.45 to 0.60 mass %, wherein the mass % is based on the total mass of the TPO excluding water and ash content. The total nitrogen is determined according to ASTM D5291C-21.

According to the present invention, the TPO may have a total sulfur of up to 1.35 mass %, such as up to 1.30 mass %, or up to 1.25 mass %, or up to 1.20 mass %, or up to 1.15 mass %, or up to 1.10 mass %, wherein the mass % is based on the total mass of the TPO excluding water and ash content. The water content may be determined according to ASTM D4928-12R18 and the ash content may be determined according to ASTM D2415-20 (at 550° C.). The total sulfur is determined according to ASTM D5291C-21.

The TPO may have:
a total nitrogen of from 0.40 to 0.65 mass %, preferably from 0.45 to 0.65 mass %, more preferably from 0.45 to 0.60 mass %; and
a total sulfur of up to 1.35 mass %, preferably up to 1.25 mass %, more preferably up to 1.20 mass %;
wherein the mass % is based on the total mass of the TPO excluding water and ash content. The water content may be determined according to ASTM D4928-12R18 and the ash content may be determined according to ASTM D2415-20 (at 550° C.). The total nitrogen and the total sulfur are determined according to ASTM D5291C-21.

According to the present invention, the TPO may have:
a total carbon in a range of from 85.0 to 90.0 mass %, preferably from 86.0 to 90.0 mass %, more preferably from 87.0 to 90.0 mass %;
a total hydrogen in a range of 8.0 to 11.0 mass %, preferably from 8.5 to 10.5 mass %, more preferably from 9.0 to 10.0 mass %;
a C/H atomic ratio in a range of from 0.65 to 1.0, preferably from 0.70 to 0.90, more preferably from 0.70 to 0.85;
a total nitrogen of from 0.40 to 0.65 mass %, preferably from 0.45 to 0.65 mass %, more preferably from 0.45 to 0.60 mass %; and
a total sulfur of up to 1.35 mass %, preferably up to 1.25 mass %, more preferably from 0.90 to 1.20 mass %;
wherein the mass % is based on the total mass of the TPO excluding water and ash content. The water content may be determined according to ASTM D4928-12R18 and the ash content may be determined according to ASTM D2415-20 (at 550° C.). The total carbon, total hydrogen, total nitrogen and total sulfur are determined according to ASTM D5291C-21. The C/H atomic ratio is calculated from the total carbon and the total hydrogen.

According to the present invention, the TPO may have an ash content of less than 0.04 mass %, such as less than 0.03 mass %, or less than 0.02 mass %, or less than 0.01 mass %, wherein the mass % is based on the total mass of the TPO. The ash content is determined according to ASTM D2415-20 (at 550° C.).

The TPO may have a sieve residue of 250 mg/kg or less, such as 230 mg/kg or less, based on the total weight of the TPO. The sieve residue is determined according to ASTM D4870-18 (25 μm mesh size).

According to the present invention, the renewable carbon feedstock (a) may comprise a plant-based feedstock. The plant-based feedstock may be a waste plant-based feedstock. The term “waste” refers to materials that are discarded or disposed of as unsuitable or no longer useful for the intended purpose, e.g., after use.

The renewable carbon black feedstock may comprise solid components and/or liquid components. Preferably, the renewable carbon black feedstock may comprise liquid components.

The renewable carbon black feedstock preferably may comprise plant-based oils and more preferably waste plant-based oils.

The renewable carbon black feedstock (a) may comprise woods, grass, cellulose, hemicellulose, lignin, black liquor, tall oil, rubber seed oil, tobacco seed oil, castor oil, pongamia oil, crambe oil, neem oil, apricot kernel oil, rice bran oil, cashew nut shell oil, Cyperus esculentus oil, rice bran oil, rapeseed oil, linseed oil, palm oil, coconut oil, canola oil, soybean oil, sunflower oil, cotton seed oil, pine seed oil, olive oil, corn oil, grape seed oil, safflower oil, acai palm oil, jambú oil, sesame oil, chia seed oil, hemp oil, perilla oil, peanut oil, stillingia oil, cashew nut oil, brazil nut oil, macadamia nut oil, walnut oil, almond oil, hazel nut oil, beechnut oil, candlenut oil, chestnut oil or a mixture or combination of any of the foregoing.

Preferably, the renewable carbon black feedstock (a) comprises soybean oil, rapeseed oil or a mixture or combination of any of the foregoing. According to the present invention the renewable carbon black feedstock (a) may comprise rapeseed oil.

As used herein, the term “wood” refers to porous and fibrous structural tissue found in the stems and roots of trees and other woody plants. Suitable examples of wood include, but are not limited to, pine, spruce, larch, juniper, ash, hornbeam, birch, alder, beech, oak, pines, chestnut, mulberry or mixtures thereof. Suitable examples of grass include, but are not limited to, cereal grass, such as maize, wheat, rice, barley or millet; bamboos and grass of natural grassland and species cultivated in lawns and pasture. Suitable examples of lignin may include, but are not limited to, lignin removed by Kraft process and lignosulfonates.

The carbon black feedstock may have a ratio of the renewable carbon black feedstock (a) to the rubber-derived pyrolysis oil (b) of from 0.1:1 to 1:0.1, preferably from 0.3:1 to 1:0.3. According to the present invention, the carbon black feedstock may have a ratio of the renewable carbon black feedstock (a) to the rubber-derived pyrolysis oil (b) of from 0.5:1 to 1:0.5.

According to the present invention, the carbon black feedstock may comprise at least 10 wt.-%, such as least 15 wt.-%, or at least 20 wt.-%, or at least 25 wt.-%, or at least 30 wt.-%, or at least 35 wt.-%, or at least 40 wt.-%, or at least 45 wt.-% of the renewable carbon black feedstock (a), based on the total weight of the carbon black feedstock. The carbon black feedstock of the present invention may comprise 90 wt.-% or less, such as 85 wt.-% or less, or 80 wt.-% or less, or 75 wt.-% or less, or 70 wt.-% or less, or 65 wt.-% or less, or 60 wt.-% or less, or 55 wt.-% or less of the renewable carbon black feedstock (a), based on the total weight of the carbon black feedstock. A person skilled in the art will appreciate that any range between any of the explicitly disclosed lower and upper limit is herein disclosed. Accordingly, the carbon black feedstock may comprise 10 to 90 wt.-%, preferably 20 to 80 wt.-%, more preferably 40 to 60 wt.-%, most preferably 45 to 55 wt.-% of the renewable carbon black feedstock (a), based on the total weight of the carbon black feedstock.

According to the present invention, the carbon black feedstock may comprise at least 10 wt.-%, such as least 15 wt.-%, or at least 20 wt.-%, or at least 25 wt.-%, or at least 30 wt.-%, or at least 35 wt.-%, or at least 40 wt.-%, or at least 45 wt.-% of the rubber-derived pyrolysis oil (b), based on the total weight of the carbon black feedstock. The carbon black feedstock of the present invention may comprise 90 wt.-% or less, such as 85 wt.-% or less, or 80 wt.-% or less, or 75 wt.-% or less, or 70 wt.-% or less, or 65 wt.-% or less, or 60 wt.-% or less, or 55 wt.-% or less of the rubber-derived pyrolysis oil (b), based on the total weight of the carbon black feedstock. A person skilled in the art will appreciate that any range between any of the explicitly disclosed lower and upper limit is herein disclosed. Accordingly, the carbon black feedstock may comprise 10 to 90 wt.-%, preferably 20 to 80 wt.-%, more preferably 40 to 60 wt.-%, most preferably 45 to 55 wt.-% of the rubber-derived pyrolysis oil (b), based on the total weight of the carbon black feedstock.

The carbon black feedstock may comprise 20 to 80 wt.-%, preferably 25 to 75 wt.-%, more preferably 40 to 60 wt.-% of the renewable carbon black feedstock (a), and 20 to 80 wt.-%, preferably 25 to 75 wt.-%, more preferably 40 to 60 wt.-% of the rubber-derived pyrolysis oil (b), based on the total weight of the carbon black feedstock. Preferably, the carbon black feedstock may comprise 45 to 55 wt.-% of the renewable carbon black feedstock (a) and 45 to 55 wt.-% of the rubber-derived pyrolysis oil (b), based on the total weight of the carbon black feedstock.

The process of the present invention may comprise feeding an O₂-containing gas stream and a fuel stream comprising combustible material to the reactor; subjecting the combustible material to combustion in a combustion step to provide a combustion gas stream, wherein the O₂-containing gas stream and the fuel stream comprising combustible material are provided for the combustion step in amounts corresponding to a k factor in the range of from 0.5 to 1.0, wherein the k factor is the ratio of O₂ theoretically necessary for stoichiometric combustion of all combustible material in the combustion step to the total O₂ provided for the combustion step; contacting the carbon black feedstock with the combustion gas stream in a reaction step to form carbon black; and terminating the carbon black formation reaction in a terminating step.

The k factor is the ratio of O₂ theoretically necessary for stoichiometric combustion of all combustible material in the combustion step to the total O₂ provided for the combustion step. Accordingly, a k factor of 1 signifies a stoichiometric combustion. In the case of excess 02, the k factor is less than 1.

The fuel stream according to the present invention can be any material that is combustible. Preferably the fuel stream comprises liquid and/or gaseous hydrocarbons, hydrogen, carbon monoxide or mixtures thereof. The fuel stream may comprise at least 50 wt.-%, such as at least 70 wt.-%, such as at least 90 wt.-%, such as at least 95 wt.-% of hydrocarbons. Suitable examples for fuel stream include, but are not limited to, natural gas, coal gas, petroleum gas, petroleum type liquid fuels such as heavy oil, or coil derived liquid fuels such as creosote oil, fuel oil, wash oil, anthracene oil and crude coal tar. Preferably, the fuel stream comprises natural gas. Alternatively, the fuel stream may comprise plasma gas. The fuel stream is subjected in the combustion step to combustion in order to provide a combustion gas stream.

As O₂-containing gas stream any gas stream can be used that comprises oxygen gas. Suitable examples of O₂-containing gas stream include, but are not limited to, air, oxygen-reduced air and oxygen-enriched air.

The combustion may be performed at a temperature in a range of from 1,000 to 2,700° C., preferably from 1,200 to 2,400° C., more preferably from 1,300 to 2,300° C.

According to the invention the k factor may further be in the range of from 0.6 to 1.0, preferably from 0.7 to 1.0, more preferably from 0.75 to 1.0, even more preferably from 0.8 to 1.0. The person skilled in the art will appreciate that the k factor can be easily calculated from the content and type of combustible material and the O₂ content in the feed streams and their respective flow rate.

In the process of the invention, the combustion gas generated in the combustion step may be contacted in the reaction step with the carbon black feedstock of the present invention. In the reaction step pyrolysis or cleavage of the carbon black feedstock takes place and carbon black as well as tail gas is formed.

The carbon black formation may be performed at a temperature in a range of from 1,000 to 2,000° C., preferably from 1,100 to 1,900° C., more preferably from 1,300 to 1,900° C., most preferably from 1,300 to 1,800° C.

According to the invention, the carbon black formation may be terminated in the termination step. Termination of the carbon black formation can be achieved by any means known to the person skilled in the art, such as cooling by direct or indirect heat exchange, for example by using a quench boiler and/or by quenching. Typically, quenching is achieved by injecting a suitable quench liquid, such as water. Preferably, the carbon black formation is terminated by water quenching.

According to the present invention, the process may be carried out in a furnace-black reactor including producing a combustion gas stream in the combustion zone, and passing the combustion gas from the combustion zone through the reaction zone into the terminating zone, injecting the carbon black feedstock into the combustion gas in the reaction zone to form carbon black and terminating carbon black formation in the termination zone by lowering the temperature by quenching and/or by using a quench boiler. The furnace black reactor of the present invention may have, along the reactor axis, a combustion zone, a reaction zone and a termination zone. Suitable furnace-black reactors are described in, e.g., EP 2 479 223 A1 or EP 1 233 042 A2.

The present invention further relates to a carbon black obtained by the process of the present invention described above.

According to the present invention, the carbon black of the present invention may have an oil absorption number (OAN) of equal to or more than 70 mL/100 g, such as equal to or more than 80 mL/100 g. The carbon black of the present invention may have an oil absorption number (OAN) of 150 mL/100 g or less, such as 145 mL/100 g or less, or 140 mL/100 g or less, or 135 mL/100 g or less, or 130 mL/100 g or less. The carbon black according to the present invention can have an OAN in a range between any of the recited lower and upper limit values. The carbon black may have an oil absorption number in a range of from 70 to 145 mL/100 g, preferably from 80 to 130 mL/100 g. The OAN is determined according to ASTM D2414-21.

According to the present invention, the carbon black may have a difference (gap) between the OAN and COAN (OAN-COAN) of at least 10 mL/100 g, such as at least 12 mL/100 g, or at least 15 mL/100 g, or at least 20 mL/100 g. The carbon black may have a difference (gap) between the OAN and COAN (OAN-COAN) of 50 mL/100 g or less, such as 45 mL/100 g or less, or 40 mL/100 g or less, or 35 mL/100 g or less, or 30 mL/100 g or less. A person skilled in the art will appreciate that any range between any of the explicitly disclosed lower and upper limit is herein disclosed. Accordingly, the carbon black may have a difference (gap) between the OAN and COAN (OAN-COAN) in a range of from 10 to 45 mL/100 g, preferably from 12 to 35 mL/100 g, more preferably from 12 to 30 mL/100 g. The OAN is determined according to ASTM D2414-21 and COAN is determined according to ASTM D3493-21. The gap in the described ranges may provide for good dispersibility of the carbon blacks in composition, in particular in rubber and/or plastic compositions.

According to the present invention, the carbon black may have a statistical thickness surface area (STSA) of no more than or equal to 90 m²/g, such as no more than or equal to 85 m²/g. The carbon black may have a STSA of at least 20 m²/g, such as at least 23 m²/g, or at least 25 m²/g. A person skilled in the art will appreciate that any range between any of the explicitly disclosed lower and upper limit is herein disclosed. Accordingly, the carbon black may have a STSA in a range of from 20 to 90 m²/g, preferably from 23 to 90 m²/g, more preferably 25 to 85 m²/g. The STSA is determined according to ASTM D6556-19a. A low STSA may provide for a low rolling resistance and low heat build-up.

The carbon black of the present invention may have BET surface area of at least 20 m²/g, such as at least 23 m²/g, or at least 25 m²/g. The carbon black may have a BET surface area of 120 m²/g or less, such as 110 m²/g or less, or 100 m²/g or less. A person skilled in the art will appreciate that any range between any of the explicitly disclosed lower and upper limit is herein disclosed. Accordingly, the carbon black may have a BET surface area in a range of from 20 to 120 m²/g, preferably from 23 to 110 m²/g, further preferably from 25 to 100 m²/g. The BET surface area is determined according to ASTM D6556-19a.

According to the present invention, the carbon black may have a sulfur content of no more than 2.5%, preferably no more than 2.0%, more preferably no more than 1.5%. The sulfur content is determined according to ASTM D1619-20.

The carbon black of the present invention can have a pMC (percent of modern carbon) of 30% or more, such as 32% or more, or 35% or more, or 37% or more, or 40% or more, or 42% or more, or 45% or more, or 47% or more, or 50% or more, or 52% or more, or 55% or more, or 57% or more, or 60% or more, or 62% or more, 65% or more, or 67% or more, or 70% or more, or 72% or more, or 75% or more, or 77% or more, or 80% or more, or 82% or more, or 85% or more, or 87% or more, or 90% or more, or 92% or more, or 95% or more, or 97% or more, or 99% or more. The pMC is determined according to ASTM D6866-20 Methode B (AMS). For each sample, a ratio of ¹⁴C/¹³C is calculated and compared to measurements made on Oxalic Acid Il standard (NIST-4990C). The measured values (pMC) are corrected by d13C measured using an isotope ratio mass spectrometer (IRMS). The carbon black of the present invention can have a pMC (percent of modern carbon) of 30% or more, preferably of 40% or more, more preferably of 50% or more, even more preferably of 75% or more, most more preferably of 90% or more.

According to the present invention, the carbon black may be a furnace black.

According to the present invention, the carbon black can be oxidized. Herein, the term “oxidized” means that the carbon black has been subjected to an oxidative treatment and thus comprises oxygen-containing functional groups. Oxidized carbon blacks, unlike non-oxidized carbon blacks, thus generally have a notable oxygen content and have oxygen-containing functional groups, which can be exemplified, but are not limited to, quinone, carboxyl, phenol, lactol, lactone, anhydride and ketone groups. For example, oxidized carbon blacks can have an oxygen content of 0.5 wt.-% or more, such as 1 wt.-% or more, or 2 wt.-% or more, based on the total weight of the oxidized carbon black material. Typically, the oxygen content does not exceed 20 wt.-%, based on the total weight of the oxidized carbon black material. For example, the oxidized carbon black can contain from 0.5 wt.-% to 20 wt.-%, or from 1 wt.-% to 15 wt.-%, or from 2 wt.-% to 10 wt.-%, or from 2 wt.-% to 5 wt.-% of oxygen, based on the total weight of the oxidized carbon black material.

Oxidized carbon blacks can be produced by various methods known in the art such as for example disclosed in U.S. Pat. Nos. 6,120,594 and 6,471,933. Suitable methods include oxidation of a carbon black material with an oxidizing agent as for example peroxides such as hydrogen peroxide, persulfates such as sodium and potassium persulfates, hypohalites such as sodium hypochlorite, ozone or oxygen gas, transition metal-containing oxidants such as permanganate salts, osmium tetroxide, chromium oxides, ceric ammonium nitrates or oxidizing acids such as nitric acid or perchloric acid, and mixtures or combinations thereof.

According to the present invention, the carbon black can further be functionalized. Carbon blacks can be functionalized by treatment using functionalizing agents. Functionalized carbon blacks can for example be obtained by treating an oxidized carbon black with a sulfur-containing primary or secondary amine or a salt thereof as described in WO 2021/001156 A1. Accordingly, the treatment leads to a chemical change of the oxidized carbon black by the sulfur-containing amine imparting functionalities derived from the treatment agent such as sulfur-containing moieties and/or amine groups to the oxidized carbon black.

The present invention further relates to use of the carbon black according to the present invention as reinforcing filler or additives, UV stabilizer, conductive carbon black or pigment, preferably reinforcing filler or additives.

Furthermore, the present invention relates to use of the carbon black according to the present invention in rubber and rubber mixtures, plastics, inks such as printing inks, inkjet inks or other inks, toners, lacquers, coatings, papers, adhesives, in batteries or black matrix applications, preferably in rubber and rubber mixtures or plastics.

In addition, the present invention relates to a rubber composition. The rubber composition of the present invention comprises at least one rubber material and at least one carbon black according to the present invention. The terms “rubber”, “rubber material” and “elastomer” may be used interchangeably throughout this description unless otherwise stated. Rubbers that can be used according to the present invention include those containing olefinic unsaturation, i.e. diene-based rubber materials, as well as non-diene-based rubber materials. The term “diene-based rubber materials” is intended to include both natural and synthetic rubbers or mixtures thereof.

Natural rubber can be used in its raw form and in various processed forms conventionally known in the art of rubber processing. Natural rubber can for example be obtained from rubber trees (Helvea brasiliensis), guayule, and dandelion.

Synthetic rubber can comprise styrene-butadiene rubber such as emulsion-styrene-butadiene rubber and solution-styrene-butadiene rubber, polybutadiene, polyisoprene, ethylene-propylene-diene rubber, ethylene-propylene rubber, butyl rubber, halogenated butyl rubber, chlorinated polyethylene, chlorosulfonated polyethylene, acrylonitrile-butadiene rubber, hydrogenated acrylonitrile-butadiene rubber, polychloroprene, acrylate rubber, ethylene-vinylacetate rubber, ethylene-acrylic rubber, epichlorohydrin rubber, silicone rubber, fluorosilicone rubber, fluorocarbon rubber or mixture of combinations of any of the foregoing. According to the invention, the synthetic rubber can also be obtained from a renewable source material. For example, polybutadiene can be produced from alcohol obtained through fermentation of plant biomass.

Suitable rubbers may also include functionalized rubbers and rubbers coupled to silicon or tin. For example, rubbers can be functionalized with functional groups like amine, alkoxy, silyl, thiols, thioesters, thioether, sulfanyl, mercapto, sulfide or combinations thereof. The one or more functionalities can be primary, secondary or tertiary and can be located at one or both chain ends (e.g. α,ω-functionalization), pendant from the polymer backbone and/or provided within the chain of the polymer backbone. The rubber according to the invention can also be partially cross-linked. Thus, prior to use in the composition of the present invention, part of the polymer chains of the rubber material can be cross-linked either by means of a coupling agent or without.

The composition according to the invention can in particular be a curable composition, such as for example a vulcanizable rubber composition. The term “vulcanizable rubber composition” refers to a composition of a rubber component optionally with various further ingredients conventionally used in the art of rubber compounding that can be cured by vulcanization under formation of a vulcanizate. The terms “curable” and “vulcanizable” are used interchangeably throughout this description unless otherwise stated and refer to a chemical reaction linking polymer chains to each other by means of a cross-linker or vulcanizing agent. The curing reaction can be induced by any means known in the art such as by light, moisture, heat and/or addition of a crosslinker.

The rubber material can comprise 5 phr or more of natural rubber, such as 10 phr or more, or 15 phr or more, or 20 phr or more, or 30 phr or more, or 40 phr or more, or 50 phr or more, or 60 phr or more, or 70 phr or more, or 80 phr or more. As used herein, the term “phr” refers to parts by weight of the recited respective material per 100 parts by weight of rubber or elastomer. The rubber material can comprise 100 phr or less of natural rubber, such as 95 phr or less, or 90 phr or less, or 85 phr or less, or 80 phr or less, or 75 phr, or less 70 phr or less, or 65 phr or less, or 60 phr or less. The rubber material can comprise natural rubber in a range between any of the recited lower and upper limits. For example, the rubber material can comprise natural rubber in a range of 5 to 95 phr, such as in a range of 10 to 90 phr, or in a range of 20 to 80 phr, or in a range of 30 to 70 phr, or in a range of 40 to 60 phr. According to the present invention, the rubber material can consist of natural rubber.

The rubber material can comprise 5 phr or more of synthetic rubber, such as 10 phr or more, or 15 phr or more, or 20 phr or more, or 30 phr or more, or 40 phr or more, or 50 phr or more, or 60 phr or more, or 70 phr or more, or 80 phr or more. The rubber material can comprise 100 phr or less of synthetic rubber, such as 95 phr or less, or 90 phr or less, or 85 phr or less, or 80 phr or less, or 75 phr, or less 70 phr or less, or 65 phr or less, or 60 phr or less. The rubber material can comprise synthetic rubber in a range between any of the recited lower and upper limits. For example, the rubber material can comprise synthetic rubber in a range of 5 to 95 phr, such as in a range of 10 to 90 phr, or in a range of 20 to 80 phr, or in a range of 30 to 70 phr, or in a range of 40 to 60 phr. According to the present invention, the rubber material can consist of synthetic rubber.

The rubber material can comprise from 5 to 100 phr of natural rubber and from 5 to 100 phr of synthetic rubber, such as from 10 to 90 phr of natural rubber and from 10 to 90 phr of synthetic rubber, or from 20 to 80 phr of natural rubber and from 20 to 80 phr of synthetic rubber, or from 30 to 70 phr of natural rubber and from 30 to 70 phr of synthetic rubber, or from 40 to 60 phr of natural rubber and from 40 to 60 phr of synthetic rubber, or from 40 to 100 phr of natural rubber and from 5 to 60 phr of synthetic rubber, or from 50 to 95 phr of natural rubber and from 5 to 50 phr of synthetic rubber, or from 60 to 90 phr of natural rubber and from 10 to 50 phr of synthetic rubber, or from 5 to 40 phr of natural rubber and from 60 to 100 phr of synthetic rubber, or from 10 to 20 of natural rubber and from 80 to 90 phr.

The rubber composition according to the present invention may comprise the carbon black of the present invention in an amount of 3 phr or more, such as 5 phr or more, or 10 phr or more, 15 phr or more, 20 phr or more, 25 phr or more, 30 phr or more, 40 phr or more, 50 phr or more. As used herein, the term “phr” refers to parts by weight of the recited respective material per 100 parts by weight of rubber or elastomer. The rubber composition can comprise the carbon black of the present invention in an amount of 200 phr or less, such as 190 phr or less, or 180 phr or less, or 150 phr or less, or 130 phr or less, or 110 phr or less, or 100 phr or less. The rubber composition according to the present invention can comprise the carbon black of the present invention in an amount between any of the recited lower and upper limit values. For example, the rubber composition according to the present invention can comprise the carbon black of the present invention in an amount of 3 to 200 phr, such as 5 to 190 phr, or 10 to 150 phr, or 20 to 130 phr, or 30 to 100 phr.

The rubber composition according to the present invention may also comprise at least one vulcanizing agent. Possible vulcanizing agents include any vulcanizing agents known from the art such as sulfur and sulfur donors. Sulfur donors suitable for the practice of the present invention include for example dithioalkanes, dicaprolactamsulfides, polymeric polysulfides, sulfur olefin adducts, thiurams and sulfonamides with at least two sulfur atoms in the sulfur bridges. Preferably elemental sulfur may be used. The vulcanizing agent may typically be used in an amount ranging from 0.5 to 10 phr, such as from 1 to 5 phr, in the rubber composition according to the present invention.

The rubber composition according to the invention may further comprise one or more other additives commonly used in the art of formulation. Such additives include, for example, curing aids such as primary and secondary vulcanization accelerators, activators, and pre-vulcanization inhibitors, processing additives such as oils, waxes, resins, plasticizers, softeners, or rheology modifiers, pigments, peptizing agents, coupling agents, surfactants, biocides and anti-degradants such as heat or light stabilizers, anti-oxidants and anti-ozonants. The person skilled in the art will select such optional additives and their respective amounts in accordance with the desired properties and/or application of the rubber composition. Useful as primary and secondary vulcanization accelerators are for example guanidines, dicarbamates, dithiocarbamates, thiurams, thioureas, 2-mercaptobenzothiazole, benzothiazole sulfonamides, aldehydeamines, amines, disulfides, thiazoles, xanthates, and sulfenamides. As specific examples it may be referred for instance to N-tert-butyl-2-benzothiazyl sulfenamide commercially available under the tradename Rhenogran TBBS-80 from Rhein Chemie Additives. Suitable vulcanization activators that can be used in the rubber composition according to the present invention include for example combinations of zinc oxide or the like with a fatty acid like stearic, lauric, palmitic, oleic or naphthenic acid. If used, such activators are typically employed in amounts of 1 to 10 phr, such as 2 to 5 phr.

Further additives may include metal oxides, metal hydroxides and filler materials such as metal oxides, metal hydroxides, and filler materials such as silica, preferably precipitated and fumed silicas, organo-silica, carbon nanotubes, carbon fibers, graphite and metal fibers as well as organosilanes, such as bis(trialkoxysilylalkyl) oligo- or polysulfide.

The rubber composition of the present invention can be obtained and processed by common rubber processing technology. The rubber composition according to the present invention can for example be obtained by combining the carbon black of the present invention and any optional ingredients, if used, with the rubber material and mixing the same, e.g. to disperse the carbon black and any optional ingredients, if used, in the rubber material. Dispersion can be achieved by any means known in the art such as by mixing, stirring, milling, kneading, ultrasound, a dissolver, a shaker mixer, rotor-stator dispersing assemblies, or high-pressure homogenizers or a combination thereof. For example, a lab mixer with intermeshing rotor geometry can be used. The dispersing can for example be conducted until the carbon black is homogeneously dispersed in the rubber material resulting in a coefficient of dispersion of 8% or less, preferably 5% or less determined according to surface topography, inclusive of Medalia correction, according to the procedure described in A. Wehmeier, “Filler Dispersion Analysis by Topography Measurements”, Technical Report TR 820, Degussa GmbH as well as in DE 199 17 975 C2. The coefficient of dispersion obtained according to this method generally correlates well (e.g., with coefficient of determination >0.95) with the coefficient of dispersion determined by optical methods, such as those determined according to ASTM D2663-14, test method B.

Preparation of the rubber composition according to the present invention may for example be conducted in a multiple step process: At first, the carbon black and optionally non-curative additives, if used, may be added to the rubber material concomitantly or successively. The rubber material, the carbon black and the additives, if used, may then be mixed, typically at a temperature in a range from 40° C. to 160° C. for a total mixing time of less than 10 min, such as in a range from 2 to 8 min. Subsequently, the obtained mixture may be blended with one or more curative additives for less than 5 min, typically less than 3 min, preferably for about 2.5 min, at a temperature of less than 115° C.

The process can comprise further steps such as extrusion or cooling down the product to room temperature and storing it for further processing. The process can further comprise a curing step, which can for example be carried out by subjecting the rubber composition to thermal curing conditions, e.g., a temperature of 120-200° C. for a time of 5 minutes to 3 hours. Curing can for instance be carried out in a curing press for example at a temperature of 140-180° C. for 5 to 60 minutes at a pressure between 100 and 150 bar.

As it will be appreciated, the rubber compositions according to the invention can be utilized in various technical applications requiring polymer-based materials with carbon black filler, e.g., for imparting antistatic or electrically conductive properties, color, mechanical reinforcement and/or low hysteresis properties. Mechanical properties that are of interest, particularly for the production of tires, include tear resistance, rebound and hysteresis. The rubber compositions according to the present invention provide cured compositions which have good and beneficial mechanical properties, especially for the production of tires. Beneficial mechanical properties in accordance with the present invention are for example high tensile strength, high rebound and low hysteresis. The rubber composition according to the present invention provide cured compositions having mechanical properties which are comparable to rubber compositions comprising conventional carbon blacks.

The present invention relates to use of the rubber composition according to the present invention for producing a tire, preferably a pneumatic tire, a tire tread, a belt, a belt reinforcement, a carcass, a carcass reinforcement, a sidewall, inner liner, apex, shoulder, hump strip, chafer, a bead filler, a cable sheath, a tube, a drive belt, a conveyor belt, a roll covering, a shoe sole, a hose, a sealing member, a profile, a damping element, a coating or a colored or printed article.

Accordingly, the invention also relates to tires made of or comprising the afore-mentioned rubber composition according to the invention. The tire according to the present invention may comprise a tire tread, a belt, a belt reinforcement, a carcass, a carcass reinforcement, a sidewall, inner liner, apex, shoulder, hump strip, chafer and a bead filler, wherein at least one of the foregoing is made of or comprises a rubber composition according to the invention. Such tires include for example, without being limited thereto, truck tires, passenger tires, off-road tires, aircraft tires, agricultural tires, and earth-mover tires.

Preferably, the tire has a circumferential tread of a cap/base configuration comprising a comprising a circumferential outer tread cap rubber layer which contains a running surface for the tire and a tread base rubber layer at least partially underlaying said tread cap rubber layer, wherein at least one of said tread cap rubber layer and said tread base rubber layer is made of or comprises a rubber composition according to the present invention.

The present invention further relates to an article made of or comprising the rubber composition according to the present invention being a cable sheath, a tube, a drive belt, a conveyor belt, a roll covering, a shoe sole, a hose, a sealing member, a profile, a damping element, a coating or a colored or printed article.

The invention further relates to a plastic composition. The plastic composition comprises at least one plastic material and at least one carbon black of the present invention.

The at least one plastic material may comprise a thermoplastic polymer, a thermosetting polymer, a thermoplastic elastomer, preferably low and high density polyethylene and polypropylene, polyvinyl chloride, melamine-formaldehyde resin, phenolic resin, epoxy resin, polyamide, polyester, polyoxymethylene, polymethyl methacrylate, polycarbonate, polystyrene, polyurethane, polyphenylene oxide, polysiloxane, polyacryloamide, polyaryletherketone, polysulfone, polyetherimide, acrylonitrile styrene acrylate or acrylonitrile butadiene styrene polymer and mixtures or co-polymers of any of the foregoing.

### Examples

The invention will now be further illustrated by the following Examples. All parts and percentages mentioned herein are based on weight, unless indicated otherwise.

### Carbon Black Production

A furnace carbon black reactor was used to produce a carbon black according to the present invention. A rapeseed oil commercially available from UCY Energy Group (Germany) was used as the renewable carbon black feedstock. ThermoTireOil RR (commercially available from Pyrum Innovations AG (Germany)) was used as the rubber-derived pyrolysis oil. The ThermoTireOil RR was subjected to a fractional distillation. The fractions of the distilled ThermoTireOil RR with a flash point of at least 65° C. were used. The flash point was determined according to ASTM D93 B.

The carbon black feedstocks of Table 1 were used for the production of the carbon blacks.

TABLE 1

| Example | 1 | 2 | 3 | 4 |
|---|---|---|---|---|
| Rapeseed oil [wt.-%] | 100 | 75 | 50 | 25 |
| Rubber-derived | — | 25 | 50 | 75 |
| pyrolysis oil [wt.-%] | | | | |

The carbon black feedstocks of Examples 2 to 4 were circulated for 8 hours by using a centrifugal pump to achieve homogeneous blending.

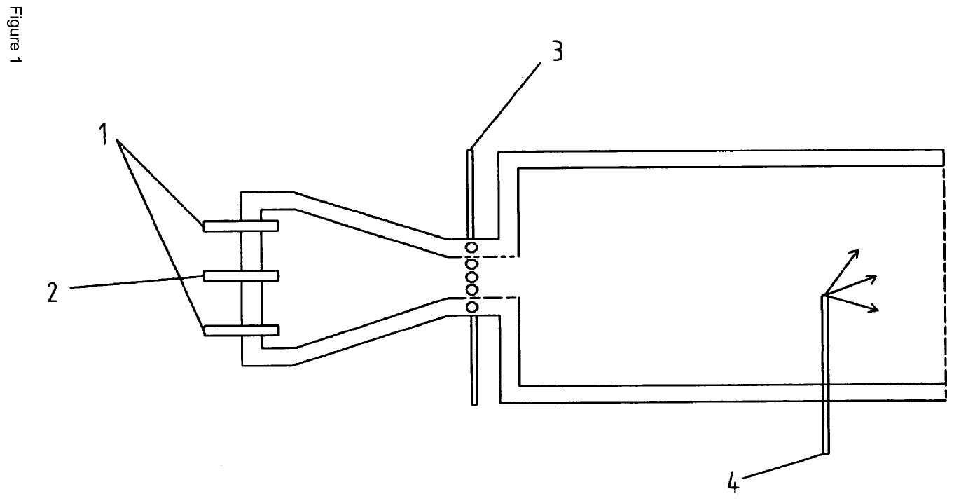

The carbon black reactor shown in FIG. 1 was used to produce a series of carbon blacks.

FIG. 1 shows a longitudinal section through the furnace black reactor. The reactor has a combustion chamber in which the hot process gas for the pyrolysis of the carbon black feedstock is produced through combustion of natural gas with introduction of atmospheric oxygen at a temperature of about 2,000° C.

The combustion air and the fuel are introduced by way of the apertures 1 in the end of the combustion chamber. The combustion chamber narrows in the manner of a cone towards the narrowest section. The carbon black feedstock is introduced at the narrowest section through nozzles by way of radial lances 3 and/or axially by way of lance 2. After passage through the narrowest section, the reaction gas mixture expands into the reaction chamber.

In the termination zone, water is sprayed into the system through the quench-water lance 4.

The list below gives the dimensions of the reactor used (Table 2).

TABLE 2

| | |
|---|---|
| Maximum combustion chamber diameter | 220 mm |
| Combustion chamber length as far as | 556 mm |
| narrowest section | |
| Length of conical portion of combustion | 256 mm |
| chamber | |
| Diameter at narrowest section | 44 mm |
| Length of narrowest section | 100 mm |
| Reaction chamber diameter | 200 mm |
| Maximum position of quench-water lance(s)¹ | |

¹measured from entry into the narrowest section (+: after entry −: prior to entry)

Table 3 lists the reactor parameters for producing carbon blacks according to the invention.

TABLE 3

| | Exam- | Exam- | Exam- | Exam- |
|---|---|---|---|---|
| Reactor parameter [unit] | ple 1 | ple 2 | ple 3 | ple 4 |
| Choke diameter [mm] | 44 | 44 | 44 | 44 |
| Tunnel diameter [mm] | 124 | 124 | 124 | 124 |
| Combustion stream [Nm³/h] | 200 | 200 | 200 | 200 |
| Combustion stream | 410 | 413 | 427 | 429 |
| temperature [° C.] | | | | |
| Fuel (natural gas) [Nm³/h] | 19 | 19 | 19 | 19 |
| Carbon black feedstock | 17 | 20 | 22 | 23 |
| [kg/h] | | | | |
| Temperature of carbon | 150 | 150 | 150 | 150 |
| black feedstock [° C.] | | | | |
| k factor [%] | 90 | 90 | 90 | 90 |

The carbon blacks of Example 1 to 4 were wet beaded according to the method described in paragraph of EP 3 960 491 A1. The respective carbon black powder was introduced into a stationary batch mixer (so called “Papenmeier”, type GRP 625/1.0 commercially available from Geppert Rührtechnik GmbH (Germany)). Deionized water was then slowly added under agitation (300 rpm) until the carbon black started to granulate, which is typically at a weight ratio of about 1:1, subsequently the agitation speed increased to 600 to 800 rpm. The thus obtained mixture was then homogenized on a roller block with a plastic drum having a length of 600 mm and a diameter of 350 mm at 28 rpm for 10 minutes. Thereafter, the beaded material was dried in an oven at 120° C. until the residual moisture content was <1%. The moisture content can be determined according to ASTM D1509-18.

The properties of the beaded carbon blacks of Example 1 to 4 were determined and are listed in Table 4.

TABLE 4

| Property | Standard | Ex. 1 | Ex. 2 | Ex. 3 | Ex. 4 |
|---|---|---|---|---|---|
| OAN [mL/100 g] | ASTM D2414-21 | 73.5 | 91.7 | 101 | 112 |
| COAN | ASTM D3493-21 | 57.8 | 68.4 | 71.4 | 78.7 |
| [mL/100 g] | | | | | |
| Gap | Calculated | 15.7 | 23.3 | 29.6 | 33.3 |
| (OAN − COAN) | | | | | |
| [mL/100 g] | | | | | |
| STSA [m²/g] | ASTM D6556-19a | 90 | 63 | 75 | 74 |
| BET [m²/g] | ASTM D6556-19a | 96 | 67 | 81 | 81 |
| Sulfur content | ASTM D1619-20 | 0.05 | 0.35 | 0.46 | 0.57 |
| [%] | | | | | |

The carbon blacks of Examples 1 to 4 and the following commercially available carbon blacks, which are obtained using conventional feedstock were used to prepare rubber compositions.
Corax® N326: Furnace black with an STSA of about 77 m²/g, an OAN of about 72 mL/100 g, and a COAN of about 69 mL/100 g, commercially available from Orion Engineered Carbons GmbH
Corax® N330: Furnace black with an STSA of about 76 m²/g, an OAN of about 102 mL/100 g, and a COAN of about 88 mL/100 g, commercially available from Orion Engineered Carbons GmbH

The STSA, OAN, and COAN of the commercially available carbon blacks are determined as described in Table 4.

### Preparation of Rubber Compositions

The rubber compositions of the formulations set forth in Table 5 were prepared according to the following procedures using the aforementioned carbon blacks.

TABLE 5

| Ingredient | Amount (phr) |
|---|---|
| ESBR Buna SB 1500¹ | 100 |
| Carbon Black | 50 |
| ZnO | 3 |
| Stearic acid | 2 |
| Vulkanox 4020/LG² | 1 |
| Sulfur | 1.5 |
| Vulkacit CZ/EG-C³ | 1.5 |

¹ESBR rubber, available from Resinex Deutschland GmbH
²Antioxidant, available from Lanxess
³Vulcanization accelerator, available from Lanxess

The ESBR Buna SB 1500 was introduced to a laboratory mixer GK4N with a tangential rotor geometry made by Harburg Freudenberger and milled for 30 seconds at a chamber temperature of 40° C. and a rotor speed of 33 rpm. Subsequently, half of the carbon black, ZnO, stearic acid, and Vulkanox 4020/LG, were added in the indicated amounts under stirring and mixed for 98 seconds. Then the other half of carbon black and Vulkanox 4020/LG were given into the mixer. After further 90 seconds the ram was lifted and cleaned and the batch was mixed again for 90 seconds. After in total 5 minutes, the batch was dropped on an open mill for cooling down and additional distributive mixing. The batch temperature did not exceed 160° C. in the first mixing step. In a second mixing step the sulfur and the accelerator (Vulkacit CZ/EG-Z) were then added in the indicated amounts to the master batch obtained from the first mixing step. The resulting mixture was milled in the GK4N mixer at a chamber temperature of 40° C. for 2 minutes. The rotor speed was 23 rpm and it was secured that the batch temperature did not exceed 105° C. Subsequently, the mixture was processed again on an open mill. The resulting vulcanizable compositions (green compounds) were cured for about 13 minutes at a temperature of 160° C.

The thus prepared rubber compositions were analyzed for their physical properties according to following methods of Table 6.

TABLE 6

| Property | Standard |
|---|---|
| Modulus 300% | DIN 53 504: 2017-03 |
| Abrasion | DIN ISO 4649: 2014-03 |
| Complex Modulus E* | Loss factor tan δ, storage modulus E′ and |
| Storage Modulus E′ | complex modulus E* were measured |
| Loss factor tan δ | according to DIN 53 513: 2019-03 in strain- |
| | controlled mode (1 ± 0.5 mm) on a cylindrical |
| | specimen (10 mm in height and 10 mm in |
| | diameter) at 60° C. with a frequency of 16 Hz. |

The results are summarized in Table 7 below.

TABLE 7

| Example | 5 | 6 | 7 | 8 | 9 | 10 |
|---|---|---|---|---|---|---|
| Carbon black | Ex. 1 | Ex. 2 | Ex. 3 | Ex. 4 | Corax ® | Corax ® |
| | | | | | N330 | N326 |
| Modulus | 7.8 | 8.9 | 9.9 | 12.8 | 15.6 | 10.3 |
| 300% [MPa] | | | | | | |
| Abrasion | 105 | 94 | 88 | 84 | 75 | 92 |
| [mm³] | | | | | | |
| Complex | 7.02 | 7.13 | 7.71 | 8.05 | 8.66 | 7.69 |
| Modulus E* | | | | | | |
| [MPa] | | | | | | |
| Storage | 6.91 | 7.05 | 7.62 | 7.96 | 8.54 | 7.58 |
| Modulus E′ | | | | | | |
| [MPa] | | | | | | |
| Loss factor tan | 0.176 | 0.149 | 0.153 | 0.152 | 0.162 | 0.176 |
| δ [—] | | | | | | |

1. A process for producing carbon black through thermal oxidative pyrolysis or thermal cleavage of a carbon black feedstock, wherein the carbon black feedstock comprises (a) renewable carbon black feedstock and (b) rubber-derived pyrolysis oil.

2. The process according to claim 1, wherein the rubber-derived pyrolysis oil (b) comprises tire-derived pyrolysis oil (TPO).

3. The process according to claim 1, wherein the rubber-derived pyrolysis oil (b) has:
a total carbon in a range of from 80.0 to 90.0 mass %;
a total hydrogen in a range of 8.0 to 15.0 mass %; and
a C/H atomic ratio in a range of from 0.60 to 1.0;
wherein the mass % is based on the total mass of the rubber-derived pyrolysis oil excluding water and ash content and wherein the total carbon and the total hydrogen is determined according to ASTM D5291C-21; and/or
wherein the rubber-derived pyrolysis oil has:
a total nitrogen of up to 1.00 mass %; and
a total sulfur of up to 1.35 mass %,
wherein the mass % is based on the total mass of the rubber-derived pyrolysis oil excluding water and ash content and wherein the total nitrogen and the total sulfur is determined according to ASTM D5291C-21; and/or
wherein the tire-derived pyrolysis oil (TPO) has:
a total carbon in a range of from 85.0 to 90.0 mass %;
a total hydrogen in a range of 8.0 to 11.0 mass %; and
a C/H ratio in a range of from 0.65 to 1.0;
wherein the mass % is based on the total mass of the TPO excluding water and ash content and wherein the total carbon and the total hydrogen is determined according to ASTM D5291C-21.

4. The process according to claim 1, wherein the renewable carbon feedstock (a) comprises a plant-based feedstock.

5. The process according to claim 1, wherein the renewable carbon black feedstock (a) comprises woods, grass, cellulose, hemicellulose, lignin, black liquor, tall oil, rubber seed oil, tobacco seed oil, castor oil, pongamia oil, crambe oil, neem oil, apricot kernel oil, rice bran oil, cashew nut shell oil, Cyperus esculentus oil, rice bran oil, rapeseed oil, linseed oil, palm oil, coconut oil, canola oil, soybean oil, sunflower oil, cotton seed oil, pine seed oil, olive oil, corn oil, grape seed oil, safflower oil, acai palm oil, jambú oil, sesame oil, chia seed oil, hemp oil, perilla oil, peanut oil, stillingia oil, cashew nut oil, brazil nut oil, macadamia nut oil, walnut oil, almond oil, hazel nut oil, beechnut oil, candlenut oil, chestnut oil or a mixture or combination of any of the foregoing, preferably soybean oil, rapeseed oil or a mixture or combination of any of the foregoing, more preferably rapeseed oil.

6. The process according to claim 1, wherein the carbon black feedstock has a ratio of the renewable carbon black feedstock (a) to the rubber-derived pyrolysis oil of from 0.1:1 to 1:0.1, preferably 0.3:1 to 1:0.3, more preferably 0.5:1 to 1:0.5; and/or
wherein the carbon black feedstock comprises:
(a) 10 to 90 wt.-%, preferably 20 to 80 wt.-%, more preferably 40 to 60 wt-%, most preferably 45 to 55 wt.-% of the renewable carbon black feedstock, based on the total weight of the carbon black feedstock; and/or
(b) 10 to 90 wt.-% preferably 20 to 80 wt.-%, more preferably 40 to 60 wt-%, most preferably 45 to 55 wt.-% of the rubber-derived pyrolysis oil, based on the total weight of the carbon black feedstock.

7. The process according to claim 1, comprising feeding an O₂-containing gas stream and a fuel stream comprising combustible material to the reactor; subjecting the combustible material to combustion in a combustion step to provide a combustion gas stream, wherein the O₂-containing gas stream and the fuel stream comprising combustible material are provided for the combustion step in amounts corresponding to a k factor in the range of from 0.5 to 1.0, wherein the k factor is the ratio of O₂ theoretically necessary for stoichiometric combustion of all combustible material in the combustion step to the total O₂ provided for the combustion step; contacting the carbon black feedstock with the combustion gas stream in a reaction step to form carbon black; and terminating the carbon black formation reaction in a terminating step;
wherein the k factor preferably is in the range of from 0.6 to 1.0, more preferably from 0.7 to 1.0, even more preferably from 0.75 to 1.0, most preferably from 0.8 to 1.0; and/or
wherein the reaction is carried out in a furnace-black reactor.

8. A carbon black obtained by the process according to claim 1.

9. The carbon black according to claim 8, wherein the carbon black has at least one of, more than one of or all of:
an oil absorption number (OAN) of equal to or more than 70 mL/100 g;
a difference (gap) between the OAN and COAN in a range of from 10 to 45 mL/100 g;
a statistical thickness surface area (STSA) of no more than or equal to 90 m²/g;
a BET surface area in a range of from 20 to 120 m²/g; and
a pMC (percent of modern carbon) of 30% or more
wherein the OAN is determined according to ASTM D2414-21, the COAN is determined according to ASTM D3493-21, the STSA is determined according to ASTM D6556-19a, the BET surface area is determined according to ASTM D6556-19a, and the pMC is determined according to ASTM D6866-20 Methode B (AMS).

10. Use of the carbon black according to claim 8 as reinforcing filler or additives, UV stabilizer, conductive carbon black or pigment, preferably reinforcing filler or additives.

11. Use of the carbon black according to claim 8 in rubber and rubber mixtures, plastics, inks such as printing inks, inkjet inks or other inks, toners, lacquers, coatings, papers, adhesives, in batteries or black matrix applications, preferably in rubber and rubber mixtures or plastics.

12. A rubber composition, comprising at least one rubber material and at least one carbon black according to claim 8.

13. Use the rubber composition according to claim 12, for producing a tire, preferably a pneumatic tire, a tire tread, a belt, a belt reinforcement, a carcass, a carcass reinforcement, a sidewall, inner liner, apex, shoulder, hump strip, chafer, a bead filler, a cable sheath, a tube, a drive belt, a conveyor belt, a roll covering, a shoe sole, a hose, a sealing member, a profile, a damping element, a coating or a colored or printed article.

14. A tire made of the rubber composition according to claim 12.

15. A plastic composition comprising at least one plastic material and at least one carbon black according to claim 8.
